(19) United States
(12) Patent Application Publication
(10) Pub. No.: US 2023/0040429 A1
(43) Pub. Date: Feb. 9, 2023

(54) STRAIGHT RAZOR

(71) Applicant: I-R INNOVATION IN IDEA LTD., Kfar-Saba (IL)

(72) Inventors: Ariel GRINSPUN, Kfar-Saba (IL); Haviv AIZENKRAFT, Ra'anana (IL)

(21) Appl. No.: 17/791,772

(22) PCT Filed: Jan. 8, 2021
(86) PCT No.: PCT/IL2021/050029

§ 371 Date: Jul. 8, 2022

Related U.S. Application Data
(60) Provisional application No. 62/958,803, filed on Jan. 9, 2020.

(51) Int. Cl. B26B 21/10; B26B 21/52

(52) U.S. Cl. CPC B26B 21/10; B26B 21/525

(57) ABSTRACT

A straight razor (10) comprising a permanent handle (12) and a shank (14) that are interconnected through a pivotal fixating element (24) and a disposable razor blade head (16) that includes a razor blade (62) embedded to a housing (60). The disposable razor blade head (16) is reversibly connected to the shank (14) and may be released by a fast release mechanism (30, 32, 34) after each use and be replaced by a new razor blade head.

### TECHNICAL FIELD

The present invention relates to hand held cutting tools. In particular the invention relates to straight razors.

### BACKGROUND ART

Straight razors are used by barbers and hair dressers to obtain a close shave of the face, side burns and neck that stays smoother longer. The straight razor consists of a blade that is hinged through a shank to a handle into which it slips when not in use. Traditionally, the blade of the straight razor needs to be disinfected or replaced as in U.S. Pat. No. 4,665,615, before using it on a new customer. This process is time consuming, and not ideally hygienic because even if the blade is replaced, the blade holder which comes in contact with the skin and hair is permanent. At times, the barber or hair dresser might also neglect to replace and/or disinfect the blade, and the customer is left in doubt whether the blade is indeed thoroughly disinfected, rendering unpleasant feeling. In addition, the replacement of the blade is time consuming and puts the barbers or hairdressers at risk of cutting themselves.

One solution to the problem was provided in the form of disposable straight razors, made of cheap materials that are used only once and thrown after treating a customer as in U.S. Pat. Nos. 6,438,846, and 6,438,847 and International Patent application Publication No. WO 2011/002266. However, as many professionals prefer using the traditional, heavy duty and elegant straight razors, the use of a permanent handle and a disposable blade holder (or razor blade head) was suggested as in U.S. Pat. Nos. 4,920,644, and 5,649,364, and US Pat. Application Publication No. 2014/096,395.

Nonetheless, these solutions have shortcomings that inhibit them from being a competitive alternative and substitute to the sturdy and elegant traditional straight razor.

There is still need for a straight razor having a replaceable blade that on one hand provides a sense of elegance, sufficient weight and sturdiness for obtaining a close and smooth shave and on the other hand provides a hygienic ease of use and safe blade replacing process.

### SUMMARY OF INVENTION

It is a first object of the invention to provide a straight razor having a disposable blade head characterized by a convenient and rapid replacement process of the blade head using a single hand.

It is a further object of the invention to provide a straight razor having a safe replacement procedure of the disposable blade.

It is another object of the invention to provide a sturdy straight razor that withstands the mechanical load involved with a close shave.

It is another object of the invention to provide a straight razor having means to adjust the weight of the handle to meet the needs of the professional user.

It is yet another object of the invention to provide a personalized straight razor.

It is yet even a further object of the invention to provide a variety of types of blade heads rendering a versatile straight razor for various types of shavings.

It is another object of the invention to provide a straight razor made of heavy duty yet degradable material.

In a first aspect, the invention provides a straight razor comprising: a handle; a shank comprising a connector for holding a razor blade head, at least one locking element and a fast release mechanism; and a razor blade head comprising a razor blade, a housing, a counter connector, at least one locking element being complementary to the locking elements of the shank, the razor blade being partially embedded in the housing such that a cutting edge is left exposed, the handle and the shank are permanent components and are interconnected through a pivotal fixating element, the razor blade head being disposable and is releasably connected to the shank, wherein the connector of the shank being adapted to connect to the razor blade head, the at least one locking element of the shank being adapted to lock the counter connector of the razor blade head to the connector of the shank, the fast release mechanism being adapted to release the razor blade head from the shank.

In a second aspect the invention provides a razor blade head comprising a razor blade housing, a razor blade embedded to the housing, a rectangular reception tube with an inlet orifice defined by a frame at one end of the razor blade head and characterized by at least one of: (i) a removable blade guard that covers the cutting edge of the razor blade, (ii) that the inner wall of the reception comprises at least one structural contact region having smaller inner cross sectional dimensions than the inner cross sectional dimensions of the remaining portion of the tube (iii) that the reception tube comprises at least one aperture on the face side of the tubular wall defining a locking element to a connector of a shank and (iv) a flat surface extending upward (away from the razor blade) from the frame of the orifice and in the same plane of the orifice.

In a third aspect the invention provides a kit comprising a set of islands each having a different weight, which are attachable to the handle of the razor defined above, for adjusting the weight of the handle.

In a forth aspect the invention provides a kit comprising a plurality of razor blade heads which may be all identical or which may differ from each other by at least one characteristic such as cutting edge length, face length, face exposure length, blade cross sectional profile, sharpness, grind type, and blade nose type.

The present invention provides a razor blade having a disposable razor blade head with a fast, convenient and safe replacement mechanism. Any part of the razor blade head that comes in contact with the skin can be replaced after each use, which contributes to the hygiene and comfort feeling of the customer. The razor blade of the invention provides improved stability and precision relative to other razor blades with replaceable blades. A protective cover of the blade protects the professional user from being cut and assures the customer a first time use of the blade. The invention further provides a versatile razor blade having a variety of optional disposable razor blades of different types and functionalities to attach to the permanent parts of the razor blade.

### BRIEF DESCRIPTION OF THE DRAWINGS

For better understanding of the present invention and in order to exemplify how it may be implemented in practice, several embodiments are hereby described, which should be interpreted only as non-limiting examples, with reference to the accompanying figures. It is noted that the sizes and scale of the embodiments presented in the figures are exemplary and non-limiting.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein.

FIG. 1 depicts an isometric frontal view of a razor blade with a dismantled razor blade head according to an embodiment of the invention.

FIG. 2 depicts an isometric back view of a razor blade with a dismantled razor blade head according to an embodiment of the invention.

FIG. 3 depicts an isometric frontal view of a razor blade with a razor blade head attached according to an embodiment of the invention.

FIG. 4 depicts an isometric frontal view of a razor blade in a razor blade head ejection mode according to an embodiment of the invention.

FIG. 5 depicts a cross sectional view of the shaft and razor blade head along line A-A in FIG. 3.

FIG. 6 depicts two razor blade heads with the protection cover removed having blades with different face exposures.

FIG. 7 is a block diagram representation of a kit comprising different types of razor blade heads according to the invention.

### DETAILED DESCRIPTION OF EMBODIMENTS

The present invention provides a straight razor comprising permanent handle and shank that are interconnected through a pivotal fixating element and a disposable razor blade head that includes a razor blade embedded to a housing. The shank comprises a connector for holding a razor blade head, at least one locking element and a fast release mechanism. The razor blade head comprises a razor blade, a housing, a counter connector, at least one locking element being complementary to the locking elements of the shank, the razor blade being partially embedded in the housing such that a cutting edge is left exposed. The handle and the shank are permanent components and are interconnected through a pivotal fixating element, the razor blade head being disposable and is releasably connected to the shank. The connector of the shank being adapted to connect to the razor blade head, the at least one locking element of the shank being adapted to lock the counter connector of the razor blade head to the connector of the shank, the fast release mechanism being adapted to release the razor blade head from the shank.

The term “straight razor” refers to a razor with a blade hinged through a shank to a handle that may fold into its handle. Straight razors are also referred to as open razors and cut-throat razors. It is noted that the straight razors of the invention should be distinguished from safety shaving razors that are constructed of a case holding a plurality of blades that is directly attached to a handle.

The Handle

The meaning of the handle and shank being permanent is that these parts of the straight razor are meant to be used multiple times and therefore they may be made of a more expensive materials such as wood, metal and high quality polymers, while the razor blade head is meant for a single use and is supposed to be replaced and thrown away after each use, thus it is made of more economical and preferably recyclable materials.

The handle is shaped for an easy and comfortable grip in the hand of the professional user and may have any common shape and design known in the art. The handle is usually made of two scales that are held together and at least one of them may have a groove that may cover most of the area of the handle and which accommodates an island—at thin panel that comes in contact with the hand and/or fingers that hold the straight razor.

In some embodiments, the handle has a minimal weight to provide steadiness during the shaving act. In some embodiments, the handle weighs at least 15, 20, 25, 30, 35, or 40 gr. In some embodiments, the handle weighs 10-15 gr. In some embodiments, the handle weighs 15-20 gr. In some embodiments, the handle weighs 20-25 gr. In some embodiments, the handle weighs 25-30 gr. In some embodiments, the handle weighs 30-40 gr. In some embodiments, the handle weighs 10-40 gr.

Different professionals have different preferences regarding to the weight of the straight razor and in particular the weight of the handle. To this end, the invention provides straight razors having replaceable islands, so that the weight of the handle can be adjusted according to the preference of the user by changing the weight of the island. This can be achieved by having different islands that are attachable to the handle of the razor blade, made of different materials of different specific weights. In one aspect the invention provides a kit comprising a set of handle attachable islands each having a different weight so that the user can change the island in the handle with another island having a different weight for changing the weight of the handle and the razor blade. The island may thus be reversibly attached to the handle and may have a defined weight selected from a range of 100 mg to 20 gr. In some embodiments, the island can weigh between 200 mg to 10 gr. In some embodiments, the island can weigh between 1 gr to 7 gr.

In some embodiments, the island can be personalized, for example by having the name or logo of the barber or hairdresser, or a unique ornament or design embossed, printed or adhered to the island.

As commonly abundant in the art—the handle may include a groove into which the blade folds into when not in use.

The Shank

The shank of the straight razor is a narrow support piece that is located between the tang (the upward curved end beyond the pivot that acts as a lever to help raise the blade from the handle) and the razor blade head (the blade holder). The shank is connected at one end to the handle through the pivotal fixating element and at a second end is adapted to hold and attach the disposable razor blade head through a connector.

The pivotal fixating element which connects the shank to the handle can be selected from any routinely used fixating elements in the art such as an adjustable screw or pin.

The shank comprises a connector for holding a razor blade head. The connector is a portion of the shank which can be distant and extending away from the pivotal fixating element that temporarily attaches the razor blade head to the shank. In some embodiments, the connector is a longitudinal pin that is compatible to enter into a bore of a reception tube of the razor blade head. The term “compatible” should be construed as having complementary measures and dimensions. To this end, the longitudinal pin has an outer cross sectional shape and dimensions being compatible with, or partially smaller than, the bore (the inner cross sectional shape) of the reception tube of the razor blade head. In some embodiments, the outer cross sectional shape of the longitudinal pin defines two structural contact regions being compatible (i.e having closely similar dimensions) with the structural contact regions of a reception tube of the razor blade head, so that these regions are in contact with, and compressed against the corresponding compatible regions of the inner wall (the bore) of the reception tube (cavity) of the razor blade head. In some embodiments, the structural contact regions of the shank have a tapered structure, and in some embodiments, they are tapered in both directions (i.e. toward the two ends of the pin), which eases the insertion of the longitudinal pin into the bore of the reception tube of the razor blade head and release thereof. In some embodiments the longitudinal pin has an overall rectangular shape, except for the structural contact regions.

The term “longitudinal pin” means that the pin has a long axis being considerably longer that the diameter of the pin. In some embodiments, the long axis of the pin is two folds longer, in some embodiments, five times longer and in some embodiments, ten folds longer or more than the diameter of the pin. The long axis of the longitudinal pin is usually substantially aligned with the long axis of the shank.

It is noted that in some embodiments, the longitudinal pin and the reception tube portion are reversed, i.e., the former is part of the razor blade head and the latter is part of shank.

In embodiments where the longitudinal pin has two structural contact regions, these regions may be separated by a thinner portion of the longitudinal pin. In such embodiments, the structural contact regions can be located in proximity to the far (longitudinal) ends of the longitudinal pin, and separated by a thinner portion of the longitudinal pin so the longitudinal pin has an H-shape conformation. The advantage of such a conformation is that the insertion of the pin through the bore is easier and smother while the structural contact regions provide the attaching support and sturdiness that is required under the work load while shaving.

The longitudinal pin can be shorter than the bore of the reception tube of the razor blade head, as long as the pin's length is at least half the length of the razor blade head or surpasses the center of mass point of the razor blade head. When the razor blade head is attached to the longitudinal pin. In some embodiments, the length of the longitudinal pin is at least 50%, 60% or 70% of the length of the razor blade head. In some embodiments, the length of the longitudinal pin is nearly equal to the length of the razor blade head. Accordingly, the length of the counter-connector, i.e. the bore of the reception tube of the razor blade head is 50%, 60%, 70% or full length, respectively of the length of the razor blade head to be able to accommodate the longitudinal pin.

The shank comprises at least one locking element to lock the razor blade head in place. The locking element of the shank is an element that is adapted to interact and/or connect physically or through attraction forces with a counter elements in the razor blade head in a reversible manner, which will require applying force in order to overcome the attraction forces between the locking element of the shank and the counter locking element. For example, the locking element of the shank can be a protrusion that extends from the surface of the longitudinal pin having a complementary shape to the counter locking element of the razor blade head, or a piece of magnet having opposite polarity to a magnet on the razor blade head. The at least one protrusion may be protrude from the structural contact regions of the longitudinal pin. The longitudinal pin may have at least one protrusion for locking the razor blade head. In some embodiments, the longitudinal pin may have at least two protrusions for locking the razor blade head. In some embodiments, the longitudinal pin may have at least one protrusion on each structural contact region for locking the razor blade head. In some embodiments, the longitudinal pin may have at least one protrusion on each of at least two structural contact regions for locking the razor blade head. In some embodiments, the longitudinal pin may have at least two protrusions on at least one or two structural contact regions for locking the razor blade head. In embodiments where there are two protrusions protruding from a structural contact region, these protrusions may located at opposite sides of the longitudinal pin.

The protrusions are shaped such that when the razor blade head is slid on the longitudinal pin, the protrusions slip into a compatible aperture in the surface of the reception tube of the razor blade head, and allow the reception tube to slip once it is pushed by the fast release mechanism. For example, the at least one protrusion may have trapezoid shape to allow such reversible insertion into and from the aperture in the reception tube. In some embodiments the trapezoid can have voids which are complementary to bulges that are disposed in the inner wall of the contact area of the reception tube. The complementary aperture in the razor blade head can be rectangular void for example having 2×3 mm lengths (the long side being parallel to the top to bottom axis of the razor blade head).

In other embodiments, the locking mechanism can be an annular protrusion located at least one of the contact areas which fits in an annular groove in the bore of the reception tube of the razor blade head.

The shank may have a rough surface and/or gripping stripe for a more secure grip by the user.

Fast Release Mechanism

The shank includes a fast release mechanism that can be adapted to easily and safely release the razor blade head using one hand—the hand that holds the straight razor, without any assistance of the other hand when the razor blade head needs to be replaced with a new one (for example, before applying the straight razor on a new customer). In some embodiments, the fast release mechanism is brought in contact with the razor blade head when the razor blade is connected to the shank to push the razor blade head away from the shank.

The term “fast release mechanism” means any mechanism that may be activated to release the razor blade head from its temporarily attached position to the shank and release it from the locking elements of the shank that secure it to the shank. One embodiment for such a fast release mechanism can be a sliding button located on a rail segment of the shank in proximity to the end of the longitudinal pin which is proximal to the pivotal fixating element. The sliding button is and connected to the main body of the shank with a spring, and can slide on the rail while stretching the spring. The sliding button has an outer end surface facing the counter connector edge of the razor blade head being most proximal to the shank (when the razor blade head is attached to the shank). The outer face of the sliding button that faces the razor blade head defines a contact surface of the sliding button with the razor blade head. In embodiments where the connector of the shank is a longitudinal pin and the counter-connector is a reception tube having a bore, the contact surface can be compatible with the outer surface of the orifice of the reception tube of the razor blade head. For optimal operation, the contact surface must be along the three contact areas surrounding the orifice of the counter-connecter (e.g. the orifice of the reception tube) of the razor blade head. The sliding button may extend from the top side of the shank, allowing the user to slide the button with his or her thumb, to push out the razor blade head from the connector of the shank. Therefore, the sliding button can release the razor head from the shank in response to sliding of the slide button toward the razor blade head.

The sliding button (or any other selected effector) can be attached to an anchoring point on the shank with a spring or a rubber band, so that after the sliding button pushes away and releases the razor blade head the spring or rubber are relaxed and the sliding button returns back to its rest position. The spring also keeps the sliding button in please to avoid unintentional release of the razor blade head. Such return mechanism are known and the person of skill in the art would know how to adapt a return mechanism to the straight razor's shank.

In another embodiment, the release mechanism can be affected by a push button. Other one hand operated mechanisms known in the art can also be implemented to affect the release mechanism. For example, the razor blade head may be released by compressing an air pulse into the bore of the reception tube, providing sufficient pressure to release the razor blade head.

The Razor Blade Head

The razor blade head includes a razor blade housing, a counter-connector (to the shaft) and a razor blade. The razor blade head may optionally further include a removable blade guard that covers the cutting edge of the metal blade to protect the blade as well as the user. The removable blade guard is connected to the blade housing through breakable connectors.

The razor blade head comprises locking elements that are located on the counter-connector being complementary to the locking elements of the shank and being releasable by the fast release mechanism. For example, if the locking elements of the longitudinal pin of the shank are protrusions that laterally extend from the surface of the longitudinal pin (e.g. that protrude from the structural contact regions) then the razor blade head comprises apertures that are compatible by shape to these protrusions and these apertures may have edges which allow easy release of the locking elements from the apertures upon a push from the fast release mechanism allowing the slide of the razor blade head away from the shank.

In some embodiments, the blade housing, the counter-connector and the removable blade guard are thermoplastic molded parts, and the razor blade is made of metal. In some embodiments, the molded parts are made of a degradable material. In some embodiments, at least one of the razor blade head, the shank and handle are at least partially made of a degradable material.

The blade housing is adapted to embed the top portion of the razor blade, and expose the lower portion of the blade which includes the cutting edge of the blade. The razor blade is partially embedded in the housing such that a cutting edge is left exposed. The top portion of the blade which is embedded in the housing may include 50, 60, 70, 80 or even 90% of the top face of the blade. In some embodiments, the blade housing is made of two matching parts which hold the upper portion of the blade in between those two parts. The blade housing may be a single part having a cavity adapted to accommodate the upper part of the blade. In such embodiments, the blade housing is molded on the top portion of the blade, on both faces of the blade so that the blade is embedded in the blade housing. In some embodiments, the blade housing includes bosses that pass through apertures in the razor blade that affix the blade in the housing. In embodiments having the housing made of two matching parts, one part of the housing may include bosses and the opposite part includes complementary apertures to the bosses. During the manufacture process after the blade having apertures is laid through the bosses on the part of the housing having the bosses, the bosses are inserted into the complementary apertures in the opposite part of the housing and pressed to seal. The two parts of the housing can be molded separately attached and the annealed or glued on the edge opposite to edge having the blade protruding. In other embodiments the two parts of the housing can be molded together with a joint axis, and during the manufacturing process they are folded about the joint axis on the blade and then pressed to seal. The pressing may include pressing the joint axis to obtain a protrusion on the back of the razor blade head. Such protrusion may be useful, for example in removing residues of shaving cream from a client's skin after shaving.

The blade housing may be connected to the removable blade guard through thin and breakable connecting stripes. The thin connecting stripes can be broken by bending the blade guard laterally with respect to the long axes of the thin and breakable connecting stripes.

The removable blade guard is adapted to cover the cutting edge of the blade to provide protection to the barber or hairdresser. It also assures the barber or hairdresser and the client alike that it is a first time use of the razor blade. As explained above the removable blade guard can be connected to the blade housing for example through breakable connecting stripes.

The razor blade head can be attached and detached from the shank through a counter-connector being compatible with the connector of the shank. As such, the razor blade head is replaceable as it is releasably connected to the shank. As mentioned earlier, the razor blade head is meant to be disposed after each use and/or after shaving each client. Therefore the razor blade head is disposable and as such it is made of cheap disposable materials. For example, except for the blade which is typically made of stainless steel, the other parts of the razor blade head can be made of a thermoplastic polymer or additional cellulosic fibrous materials as wood, corn, bamboo, and more. Out of concern to the environment, the disposable razor blade head is made as much as possible form degradable materials such as biodegradable polymers.

The counter-connector of the razor blade head has a structure that enables a reversible connection (releasable attachment) of the razor blade head to a compatible connector portion of the shank. The counter-connector can be a reception tube of the razor blade head that has a bore, (the inner cross sectional shape of the tube), being compatible with or wider than an outer cross-sectional shape and dimensions of a longitudinal pin connector of the shank. The reception tube has an orifice defined by a frame at one end of the razor blade head in order to allow the longitudinal pin connector of the shank to enter or exit the reception tube, when the user needs to attach or replace the razor blade head, respectively. The inner wall of the tubular portion may include at least one, in some embodiments, two structural contact regions, which are being complementary to the structural contact regions of the longitudinal segment of the shank. The structural contact regions provide the grip that is required for a sturdy attachment of the shank to the razor blade head which allows it to withstand the forces that are involved when applying pressure on the razor blade head when it is pressed against the skin while shaving.

In embodiments where the longitudinal pin of the shank has an H-shaped conformation, each of the complementary structural contact regions of the reception tube of the razor blade head is located in proximity to each one of the ends of the reception tube.

In another embodiment the counter-connector of the razor blade head is a longitudinal rail located on the top of the razor blade head which is compatible to a reception tube connector located on the shank. In yet another embodiment, the counter-connector of the razor blade head is a longitudinal pin extending from the side of the razor blade head that faces the shank and is structurally compatible to a reception tube connector of the shank. The counter-connector includes at least one locking element—for example a protrusion extending the surface of the connector or an aperture being compatible to the aperture or protrusion located on the connector of the shank.

In another aspect, the invention provides a razor blade head comprising a razor blade housing, a counter-connector (to a permanent shaft of a straight razor) and a razor blade embedded to the housing. The razor blade head may further include to protect the blade as well as the user. The razor blade head may further comprise locking elements located on the counter connector for releasably locking to a shank of a straight razor. For example, the counter connector may be a reception tube that has a bore (the inner cross sectional shape of the tube), and an inlet orifice defined by a frame at one end of the razor blade head. In some embodiments the inlet orifice and the bore are rectangular allowing a rectangular shaped shank of a razor blade to enter the reception tube having the short side perpendicular to the long axis of the razor blade head. The frame the inlet orifice may define a rectangular opening of 4.4 mm×8 mm. The inner wall of the reception tube may include at least one, in some embodiments two, structural contact regions, characterized by having smaller inner cross sectional dimensions than the inner cross sectional dimensions of the remaining portion of the tube. In case there are two structural contact regions, these regions have a smaller inner diameter that the diameter of the portion of the tube that separates the two structural contact regions. The structural contact regions may provide a grip that is required for a sturdy attachment of the shank to the razor blade head when the parts are connected. This allows it to withstand the forces that are involved when applying pressure on the razor blade head when it is pressed against the skin while shaving. The reception tube may include at least one aperture, in some embodiments at least two apertures, defining a locking element to a connector of a shank and disposed on the face side of the tubular wall In some embodiments the two apertures are opposing apertures one on each face side of the tubular wall. Such an aperture may allow the entry of a protrusion of a longitudinal pin of a shank that enters the counter connector (e.g. the reception tube) of the razor blade head being complementary to the locking elements of the shank and being releasable by the fast release mechanism. In some embodiments the aperture is a rectangular aperture located in proximity to the orifice of the reception tube. In some embodiments the rectangular aperture is at least 2.8 mm long, and 2.5 mm wide (the long axis being parallel to the long axis of the tube. The reception tube may have a surface extending upward (away from the razor blade) from the frame of the orifice and in the same plane of the orifice. Such surface allows contact with a release mechanism of the shank.

The Razor Blade

The razor blade for all aspects of the invention is typically a thin piece of metal, usually martinistic stainless steel having a sharp straight edge, but may also be made of other materials available in the art such as composite materials. The top portion of the razor blade is attached to the housing and may be embedded thereto. The razor blade may have apertures through which bosses of the molded structure anchor the blade to the molded structure. Other alternatives as known in the art may be implemented in order to anchor the blade to the molded structure such as ultrasonic welding and on-core molding.

The blade may have any edge and face length, any profile, cross-sectional curvature and sharpness that are commonly used in fully permanent straight razors (i.e. straight razors that at most only the blade is replaced), to fulfill various functionalities and rendering the straight razor fully versatile. The most common edge length is a ⅝ inch edge blade but other lengths are also within the scope of the invention. The blades can have a hollow grind (a concave cross section) or a flat grind (having a hedge cross section). The blade nose (the front tip of the cutting edge of the blade) can be selected from the commonly available designs such as a sharp point, round point, French point, Spanish point or Barber's notch point. The face of the blade is partially embedded in the housing and partially exposed (when the protecting sleeve is taken off) having the cutting edge exposed. The face of the blade is the wide side of the blade that ends in the cutting edge on one side and the top edge of the blade on (the edge which is embedded in the blade housing) at the other end. The exposed portion of the face of the blade can have a vertical length in the range of 0.1 mm to 20 mm. In some embodiments, the vertical length is between 1 mm to 20 mm. In some embodiments, it has a length of between 1 mm to 10 mm. The term “exposed portion of the face of the blade” relates to the portion of the face of the blade that is visible and is between the bottom edge of the housing and the cutting edge of the blade.

Thus the straight razor of the invention may serve for any purpose that straight razors are commonly used simply by replacing the razor blade head without needing to replace the entire straight razor. For example the straight razor can be used for beard trimming, sideburns and neck haircut finishing, close shaving on rough or gentle skin, intimate shaving, body shaving, thinning and so forth.

Kits of Razor Blade Heads

The invention also provides a kits comprising a package and a plurality of razor blade heads according to the invention. The razor blades can be arranged in a manner that enables quick and easy attachment of a single razor blade head to the connector of the shank. To this end, the razor blade heads can be placed in a box in an orientation that exposes the counter connector of the razor blade heads as the box is opened. The box may include a dispenser having individual slots for each razor blade head, so that the razor blade heads are spaced apart and each one resides in its own slot. The kit may comprise a plurality of razor blade heads all having the same conformation and design or it may include razor blade heads of different sizes, shapes and designs. Thus, in some embodiments, the invention provides a kit comprising at least two different types of razor blade heads, in some embodiments—three, four, five, or ten different types of razor blade heads. The razor blade heads differ from each other by at least one of the following characteristics: cutting edge length, face length, face exposure length, blade cross sectional profile, sharpness, grind type, and blade nose type. Such a kit comprising razor blade heads of different types, or several kits each comprising a specific type of razor blade heads, would allow the professional barber to use the right type of razor blade head for a specific task. The razor blade heads may be positioned in the dispenser to enable direct access to the blade heads with the longitudinal pin of the shaft so there is no need manually release the razor head form the dispenser. The dispenser may contain any desired number of razor blade heads. In some embodiments, the dispenser contains between four to twenty units. The kit may include a dispenser of razor blade heads divided to areas for each type of razor blade head having several slots in each area, to facilitate all applications types of razor heads as previously mentioned. The dispenser will hold the razor heads to stand forces needed for the insertion of the longitudinal pin of the shaft and locking of the razor blade head thereto.

### Specific Embodiments

Although the invention is illustrated and described herein as embodied in example straight razor with a disposable razor blade head and a kit containing the latter, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

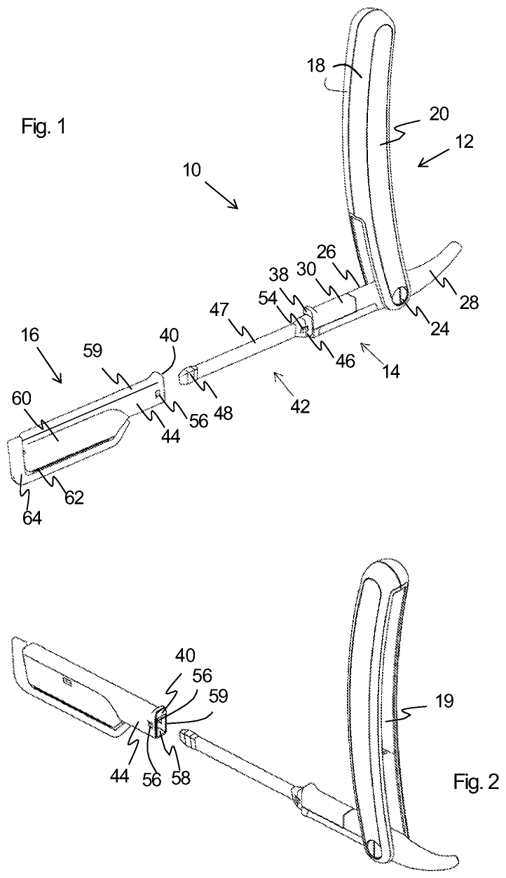

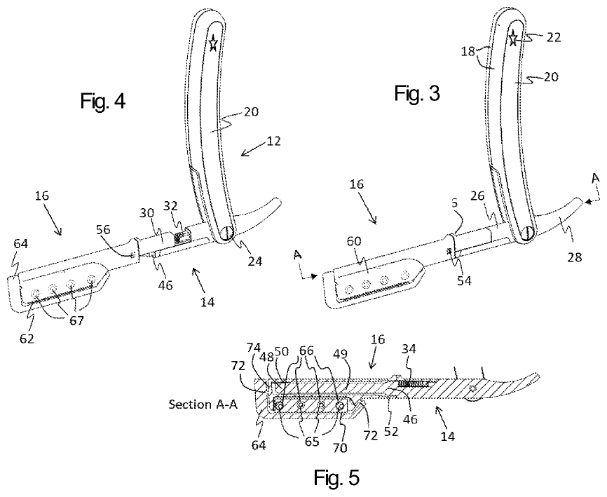

Reference is now made to FIGS. 1 and 2. A straight razor 10 is made of a handle 12, a shank 14 and a razor blade head 16. The handle 12 is made of two parts 18 that may be joined with a screw close to the end being distal from the shank (not shown). The handle 12 may have a cavity 19 that accommodates the portion of the razor blade head 16 that includes the cutting edge when the razor is not in use. Making reference to FIG. 3, the handle 12 comprises a cavity (not shown) that accommodates an island 20. The island can have an imprint 22 that personalizes the straight razor 10. The handle 12 is connected to the shank 14 through a pivotal adjustable screw 24. The shank 14 comprises a main body 26, a tang 28 and a fast release mechanism which in this embodiment is made of a sliding button 30, a rail 32 and a spring 34. The sliding button 30 slides on the rail 32, and is anchored to the main body 26 of the shank 14 by the spring 34. The sliding button 30 has a curved bulge 36 that is designed this way to make it ergonomically fit to be pushed by a finger (usually a thumb). The sliding button 30 has an outer face 38 defining a contact surface with the contact surface 40 of the razor blade head 16. The contact surface 40 is a flat surface that extends upwards (away from the blade) from the frame defining the orifice of the of the When the sliding button 30 is at rest it resides in the back position as in FIG. 3 allowing the razor blade head 16 to be affixed to the shank 14.

The shank 14 also comprises a connector which in this embodiment is a longitudinal pin 42. The longitudinal pin 42 extends from the main body 26 of the shank 14, and is designed to attach the razor blade head 16 by insertion into the counter-connector of the latter, which in this embodiment is a reception tube 44. The longitudinal pin 42 comprises two tapered contact regions 46 and 48 having at their widest diameters a cross section closely matching the cross section of the inner wall (the bore) of the reception tube 44 at the corresponding contact regions 50 and 52. At their widest diameters, the contact regions 46 and 48 apply radial force against the contact regions 50 and 52 of the bore of the reception tube, respectively holding the shank 14 and the razor blade head 16 together. The contact regions 46 and 48 have tapered endings to enable a smooth insertion into the reception tube 44. The portion 49 of the longitudinal pin 42 that connects the two contact regions 46 and 48 is thinner than these contact regions and the cross section of the inner wall of the reception tube 44, thus defining an overall H-configuration of the longitudinal pin. This also assists in a smooth insertion of the longitudinal pin 42 into the bore of the reception tube 44. When the razor blade head 16 is pressed against the skin, the two contact regions 46 and 48 provide support to the load that is put on the razor blade head 16 which gives it stability and resilience. The contact region 46 being closer to the main body 26 of the shank 14 includes locking protrusions 54 on both sides that fit to enter through compatible apertures, or windows, 56 in both faces of reception tube 44. The apertures 56 are located in proximity to the entry (or orifice) 58 of the reception tube 44 that is defined by a frame. This entry 58 should be large enough to enable the longitudinal pin 14 to enter, i.e., its inner cross section should be equal or larger than the outer cross section of the widest contact region on the longitudinal pin 14.

The razor blade head includes, in addition to the reception tube 44, a razor blade housing 60, a blade 62 and a blade protection guard 64. The reception tube 44 is located at the top portion of the razor blade head 16, such that the upper wall of the reception tube 44 is the spine 59 of the razor blade head 16.

The blade housing 60 embeds the razor blade 62. In FIGS. 3-5 an embodiment of the invention is shown in which the housing includes rods 65 that extend from one inner side of the housing 60 pass through apertures 66 in the razor blade 62 and attach to receiving apertures 67 in the other side of the housing 60. This arrangement affixes the blade 62 is affixed in place in the housing 60.

The blade guard 64 covers the cutting edge 70 of the blade 62, rendering it safe. The blade guard 64 is connected to the housing 60 and to the to the end wall 74 of the reception tube 44 through two thin stripe connectors 72. In some embodiments, the connector can connect the protection guard 64. These stripes can easily brake by twisting the protection guard 64 sidewise, thus exposing the cutting edge 70 of the blade 62 for use.

Reference is now made to FIGS. 3, 4 and 5 which depict two configurations of the razor blade of the invention. In FIGS. 3 and 5 the straight razor is in an assembled configuration wherein the razor blade head 16 is locked onto the longitudinal pin 42 (hidden). The protrusions 54 are in the apertures 56 of the reception tube 44 of the shaft 14, and the sliding button 30 as well as the spring 34 which anchors the sliding button 30 to the main body 26 of the shank 14 are at rest. In FIG. 4, the sliding button 30 is pressed forward by the user against the razor blade head 16. The sliding button 30 is dislocated forward, having the anchoring spring 34 in an extended state. The contact region 38 of the sliding button pushes the razor blade head 16 through the contact region 40 of the reception tube 44, the windows 56 of the reception tube 44 slide over the protrusions 54 of the longitudinal pin 42 and the razor blade head 16 is free to be replaced with a new one.

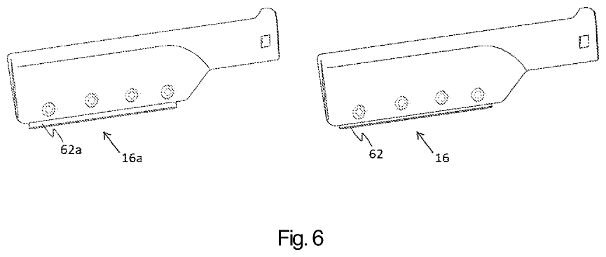

By way of example, FIG. 6 depicts two different razor blade heads 16a and 16b according to the invention each attached to a different blade 62a and 62b, respectively. The two different blades 62a and 62b vary by having a different face exposures which affects the ability to work with the blade in a different angle against the shaved area and to facilitate the different cutting tasks such trimming, designing, and face shaving.

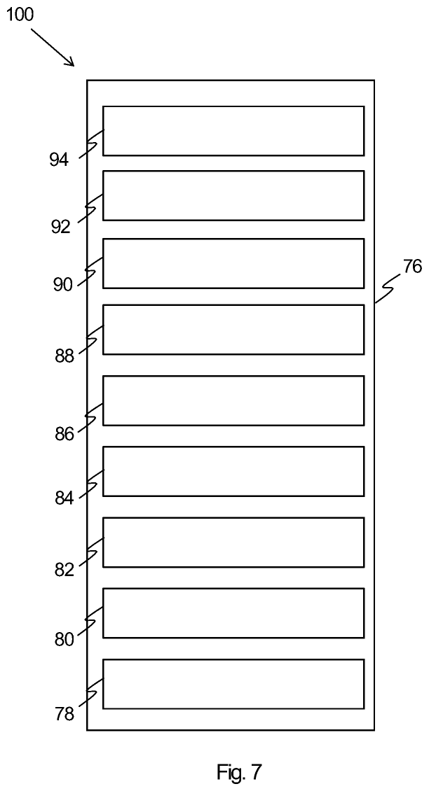

FIG. 7 schematically depicts a kit 20 accommodating in a dispenser 76 a plurality of razor blade heads 78-94, each having a different type of blade.

1. A straight razor comprising:
a handle;
a shank comprising a connector for holding a razor blade head, at least one locking element and a fast release mechanism; and
a razor blade head comprising a razor blade, a housing, a counter connector, at least one locking element being complementary to the locking elements of the shank, the razor blade being partially embedded in the housing such that a cutting edge is left exposed, the handle and the shank are permanent components and are interconnected through a pivotal fixating element, the razor blade head being disposable and is releasably connected to the shank,
wherein the connector of the shank being adapted to connect to the razor blade head, the at least one locking element of the shank being adapted to lock the counter connector of the razor blade head to the connector of the shank, the fast release mechanism being adapted to release the razor blade head from the shank.

2. The straight razor according to claim 1 wherein the razor blade head comprises a removable blade guard surrounding and/or covering the cutting edge of the blade and connected to the blade housing through breakable connectors.

3. The straight razor according to claim 1 wherein the connector of the shank is a longitudinal pin being distal to the pivotal fixating element, and the counter-connector of the razor blade head is a reception tube, wherein the outer cross sectional shape and dimensions of the longitudinal pin being compatible with or smaller than an inner cross sectional shape of the reception tube and the reception tube having an inner cross sectional shape being compatible with or wider than an outer cross sectional shape and dimensions of the longitudinal pin of the shank, and comprising an orifice defined by a frame at one end of the razor blade head.

4. The straight razor according to claim 3 wherein the outer cross sectional shape and dimensions of the longitudinal pin defining two structural contact regions with the reception tube being complementary to structural contact points of the reception tube; and the inner wall of the reception tube comprises two structural contact regions being complementary to the structural contact regions of the longitudinal segment of the shank such that the structural contact regions of the longitudinal pin press against the structural contact regions of the reception tube when the razor blade head is connected to the shaft.

5. The straight razor according to claim 3 wherein the longitudinal pin and the reception tube having a length at least 50% of the length of the razor blade head.

6. The straight razor according to claim 4 wherein the longitudinal pin of the shank is H-shaped having the structural contact regions located in proximity to each one of the ends of the longitudinal pin, and separated by a portion having an outer cross sectional diameter being smaller than the inner cross sectional diameter of the reception tube of the razor blade head, and each of the complementary structural contact regions of the reception tube of the razor blade head is located in proximity to each one of the ends of the hollow reception tube.

7. The straight razor according to claim 1 wherein the at least one locking element of the shank is a protrusion protruding from the surface of at least one of the contact regions of the longitudinal pin of the shank being complementary to a complementary apertures in the wall of the reception tube of the razor blade head.

8. The straight razor according to claim 1 wherein the release mechanism comprises
a sliding button located on a rail segment of the shank in proximity to the end of the longitudinal pin being proximal to the pivotal fixating element, and connected to the main body of the shank with a spring, the button comprising an end surface, facing the counter-connector of the razor blade head, being structural compatible to an outer surface of the orifice of the counter-connector of the razor blade head, and adapted to release the razor head from the shank in response to sliding of the slide button toward the razor blade head.

9. The straight razor according to claim 1 wherein the handle weighs at least 15, 20, 25, 30, 35, or 40 gr.

10. The straight razor according to claim 1 wherein at least one of the handle and the shank is adapted to comprise an island.

11. The straight razor according to claim 10 wherein the handle comprises a groove compatible with an island.

12. The straight razor according to claim 10 wherein the island is characterized by a personalizing ornament, logo or writing.

13. The straight razor according to claim 10 wherein the island is reversibly attached to the handle and has a defined weight selected from a range of 0.1 gr to 10 gr.

14. The straight razor according to claim 1 wherein at least one of the razor blade head, the shank and handle are at least partially made of a degradable material.

15. The straight razor according to claim 1 wherein an exposed face of the blade has a vertical length in the range of 0.1 mm to 20 mm.

16. A razor blade head comprising a razor blade housing, a razor blade embedded to the housing, a rectangular reception tube with an inlet orifice defined by a frame at one end of the razor blade head and characterized by at least one of: (i) a removable blade guard that covers the cutting edge of the razor blade, (ii) that the inner wall of the reception comprises at least one structural contact region having smaller inner cross sectional dimensions than the inner cross sectional dimensions of the remaining portion of the tube (iii) that the reception tube comprises at least one aperture defining a locking element to a connector of a shank and being disposed on the face side of the tubular wall and (iv) a flat surface extending upward (away from the razor blade) from the frame of the orifice and in the same plane of the orifice.

17. A kit comprising a set of islands each having a different weight being attachable to the handle of the straight razor according to claim 1 for adjusting the weight of the handle.

18. A kit comprising a plurality of razor blade heads as defined in claim 1 being releasably connectable to the shank of the straight razor.

19. The kit according to claim 18 comprising at least two different razor blades the two different razor blades differentiate from each other by at least one the following characteristics: cutting edge length, face length, face exposure length, blade cross sectional profile, sharpness, grind type, and blade nose type.
